(19) United States
(12) Patent Application Publication
(10) Pub. No.: US 2008/0098512 A1
(43) Pub. Date: May 1, 2008

(54) MASSAGE-ACTION SHOWERHEAD

(76) Inventor: Wen-Chieh FANG, Taipei city (TW)

Correspondence Address: LEONG C LEI, PMB # 1008, 1867 YGNACIO VALLEY ROAD, WALNUT CREEK, CA, 94598, US

(21) Appl. No.: 11/554,033

(22) Filed: Oct. 30, 2006

(51) Int. Cl. A47K 3/00

(52) U.S. Cl. 4/615

(57) ABSTRACT

A massage-action showerhead is disclosed to include a showerhead body having a water passage through the two opposite ends, a showerhead face member coupled to one end of the showerhead body and having jet nozzles for output of water passing through the water passage, an eccentric water wheel eccentrically and pivotally coupled to the showerhead face member inside the showerhead body in a tangential manner relative to the water passage and rotatable to vibrate the showerhead body by water passing through the showerhead body, a tubular handle connected to the showerhead body for the connection of a hose to guide water into the water passage, and a connector attached with shock-absorbing gaskets and coupled between the showerhead body and the tubular handle.

### BACKGROUND OF THE INVENTION

(a) Technical Field of the Invention

The present invention relates showerheads and more particularly, to a massage-action showerhead.

(b) Description of the Prior Art

A showerhead is a component of a modern bathroom for showering the body with hot or cold water desired. An old design showerhead is sued simply for showering the body. A modern showerhead provides a massage-action to massage the user's body when showering. A massage-action showerhead has a rotary or switching knob for control the speed and volume of output water. A massage-action showerhead of this design uses the impact force of running water to massage the user's body. This design of massage-action showerhead does not massage the user's body with vibration. There are known massage-action showerheads that massage the user's body by vibration. However, these massage-action showerheads commonly have a complicated vibration mechanism, and consume electricity during operation.

### SUMMARY OF THE INVENTION

The primary purpose of the present invention is to provide a massage-action showerhead, which provides a massaging effect when showering. It is another object of the present invention to provide a massage-action showerhead, which allows change of different types of showerhead face members for different massaging effects. It is still another object of the present invention to provide a massage-action showerhead, which allows regulation of water flowrate. It is still another object of the present invention to provide a massage-action showerhead, which does not consume power supply. It is still another object of the present invention to provide a massage-action showerhead, which eliminates transmission of vibration to the user's hand when massing the user's body. It is still another object of the present invention to provide a massage-action showerhead, which allows positive grasping of the hand.

To achieve these and other objects of the present invention, the massage-action showerhead comprises a showerhead body, the showerhead body having a first end, a second end, a water passage in communication between the first end and the second end; a showerhead face member coupled to the first end of the showerhead body, the showerhead face member having a plurality of jet nozzles for output of water passing through the water passage and a center pivot axle; an eccentric water wheel eccentrically and pivotally coupled to the center pivot axle of the showerhead face member inside the showerhead body in a tangential manner relative to the water passage and rotatable by water passing through the water passage toward the showerhead face member to vibrate the showerhead body; and a tubular handle connected to the second end of the hollow showerhead body for connection to a water source to guide water into the water passage.

Further, the hollow handle has a water flowrate regulating valve for regulating the flowrate of water passing through the hollow handle to the water passage, and a water flowrate control knob coupled to the water flowrate regulating valve for operation by the user to regulate the flowrate of water passing through the water flowrate regulating valve.

The massage-action showerhead further comprises a connector coupled between the hollow showerhead body and the tubular handle, and two shock-absorbing gasket rings respectively connected between the hollow showerhead body and the connector and between the connector and the tubular handle.

Further, the tubular handle has an anti-slip structure on the periphery.

Further, the showerhead face member can be made having multiple bundles of bristles fastened to a front wall thereof for massaging. Alternatively, the showerhead face member can be made having a plurality of studs, round pins, or sharp tips protruded from a front wall thereof for massaging.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a plain view of a showerhead in accordance with the present invention.

FIG. 2 is an exploded plain view of the showerhead shown in FIG. 1.

FIG. 3 is a schematic sectional view of the present invention, showing moving direction of water through the hollow showerhead body and rotation of the eccentric water wheel.

FIG. 4 is a schematic drawing showing the action of flowing water against the eccentric water wheel according to the present invention.

FIG. 5A is a sectional plain view showing an alternate form of the showerhead face member for the massage-action showerhead according to the present invention.

FIG. 5B is a sectional plain view showing another alternate form of the showerhead face member for the massage-action showerhead according to the present invention.

FIG. 5C is a sectional plain view showing still another alternate form of the showerhead face member for the massage-action showerhead according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

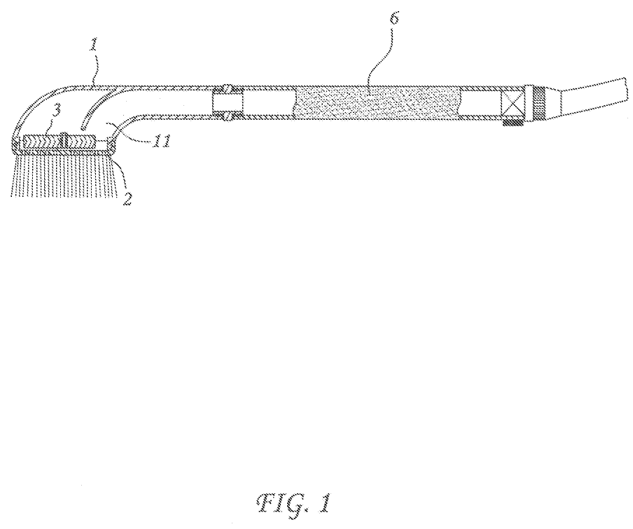

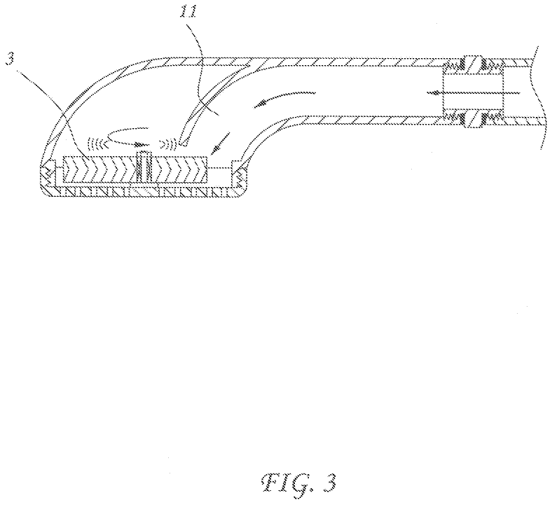

Referring to FIGS. 1, 3 and 4, a massage-action showerhead in accordance with the present invention is shown comprising a hollow showerhead body 1, which defines a water passage 11, an eccentric water wheel 3 pivotally and eccentrically mounted in the front end of hollow showerhead body 1 and rotatable by water passing through the water passage 11 to vibrate the hollow showerhead body 1, and a tubular handle 6 affixed to the hollow showerhead body 1 in fluid communication with the water passage 11 for the connection of a hose. When in use, the user can hold the handle 6 with the hand to move the hollow showerhead 1 over any part of the user's body as waster is passing through the water passage 11, thereby massaging the user's body.

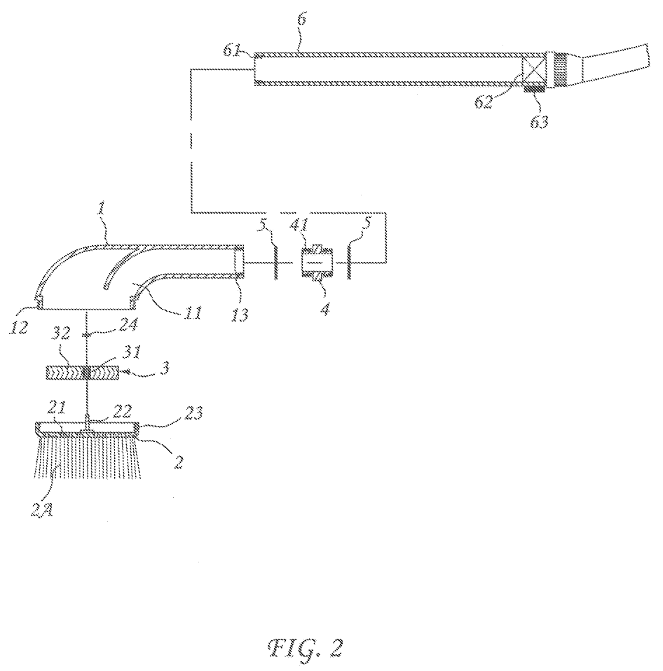

Referring to FIG. 2, the massage-action showerhead further comprises a detachable shower face member 2, a connector 4, and two shock-absorbing gasket rings 5.

Referring to FIGS. 1-4 again, the hollow showerhead body 1 has an outer thread 12 at the front end, and an inner thread 13 at the rear end. The water passage 11 extends through the front and rear ends of the hollow showerhead body 1.

The showerhead face member 2 is a flat circular cap having an inner thread 23 threaded onto the outer thread 12 of the hollow showerhead body 1, a plurality of jet nozzles 21 through which water passes out of the water passage 11 of the hollow showerhead 11, a center pivot axle 22 perpendicularly extended from the center of the back wall for supporting the eccentric water wheel 13, and bundles of bristles 2A fastened to the front wall around the jet nozzles 21.

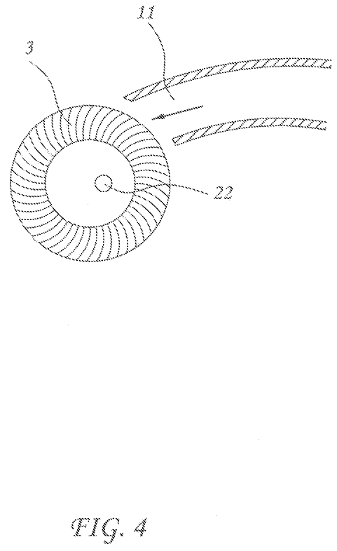

The eccentric water wheel 3 has an axle bearing 31 provided at an eccentric location and pivotally coupled to the pivot axle 22 of the showerhead face member 2 inside the hollow showerhead body 1 for allowing rotation of the eccentric water wheel 3 relative to the showerhead face member 2, and a plurality of arched blades 32 radially arranged around the axle bearing 31. When running water passes through the water passage 11, it touches the arched blades 32 tangentially (see FIG. 4) to move the eccentric water wheel 3, thereby causing the eccentric water wheel 3 to vibrate the hollow showerhead body 1.

Further, the tubular handle 6 has an inner thread 61 at the front end, a water flowrate regulating valve 62 mounted in the rear end, and a water flowrate control knob 63 coupled to the water flowrate regulating valve 62 for operation by hand to regulate the flowrate of water passing through the water flowrate regulating valve 62. The tubular handle 6 preferably has an anti-slip structure around the periphery. For example, the tubular handle 6 can be covered with a rubber covering having an embossed surface pattern for the grasping of the hand positively and comfortably.

The connector 4 has an outer thread 41 disposed at each of the two distal ends and respectively threaded into the inner thread 13 of the hollow showerhead body 1 and the inner thread 61 of the tubular handle 6.

The shock-absorbing gasket rings 5 are respectively mounted in between the rear end of the hollow showerhead body 1 and one end of the connector 4 and the other end of the connector 4 and the front end of the hollow handle 6 to prohibit water leakage and to absorb shocks, eliminating or lessening transmission of shockwaves from the hollow showerhead body 1 to the tubular handle 6.

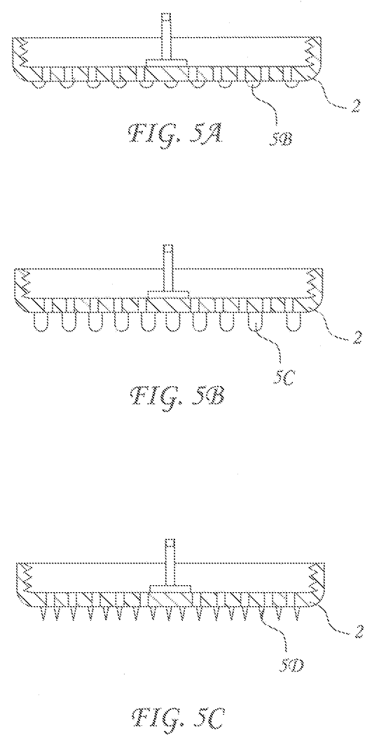

Further, the showerhead face member 2 may be variously embodied. According to the embodiment shown in FIG. 5A, the showerhead face member 2 has massaging studs 5B protruded from the front wall. According to the embodiment shown in FIG. 5B, the showerhead face member 2 has massaging round rods 5C protruded from the front wall. According to the embodiment shown in FIG. 5C, the showerhead face member 2 has sharp massaging tips 5D protruded from the front wall.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A massage-action showerhead comprising:
a showerhead body, said showerhead body having a first end, a second end, a water passage in communication between said first end and said second end;
a showerhead face member coupled to the first end of said showerhead body, said showerhead face member having a plurality of jet nozzles for output of water passing through said water passage and a center pivot axle;
an eccentric water wheel eccentrically and pivotally coupled to said center pivot axle of said showerhead face member inside said showerhead body in a tangential manner relative to said water passage and rotatable by water passing through said water passage toward said showerhead face member to vibrate said showerhead body; and
a tubular handle connected to the second end of said hollow showerhead body for connection to a water source to guide water into said water passage.

2. The massage-action showerhead as claimed in claim 1, wherein said hollow handle has a water flowrate regulating valve for regulating the flowrate of water passing through said hollow handle to said water passage, and a water flowrate control knob coupled to said water flowrate regulating valve for operation by the user to regulate the flowrate of water passing through said water flowrate regulating valve.

3. The massage-action showerhead as claimed in claim 1, wherein said eccentric water wheel has an axle bearing provided at an eccentric location and coupled to said center pivot axle of said showerhead face member.

4. The massage-action showerhead as claimed in claim 1, further comprising a connector coupled between said hollow showerhead body and said tubular handle, and two shock-absorbing gasket rings respectively connected between said hollow showerhead body and said connector and between said connector and said tubular handle.

5. The massage-action showerhead as claimed in claim 1, wherein said tubular handle has an anti-slip structure on the periphery.

6. The massage-action showerhead as claimed in claim 1, wherein said showerhead face member has multiple bundles of bristles fastened to a front wall thereof for massaging

7. The massage-action showerhead as claimed in claim 1, wherein said showerhead face member has a plurality of studs protruded from a front wall thereof for massaging.

8. The massage-action showerhead as claimed in claim 1, wherein said showerhead face member has a plurality of round pins protruded from a front wall thereof for massaging.

9. The massage-action showerhead as claimed in claim 1, wherein said showerhead face member has sharp tips protruded from a front wall thereof for massaging.
